(19) United States
(12) Patent Application Publication
(10) Pub. No.: US 2010/0119245 A1
(43) Pub. Date: May 13, 2010

(54) PAPER DISCHARGE DEVICE AND IMAGE FORMING APPARATUS

(75) Inventors: Isao YAHATA, Shizuoka-ken (JP); Hiroyuki TAKI, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/610,984

(22) Filed: Nov. 2, 2009

Related U.S. Application Data
(60) Provisional application No. 61/112,646, filed on Nov. 7, 2008.
(60) Provisional application No. 61/112,658, filed on Nov. 7, 2008.

(51) Int. Cl. G03G 15/00; B65H 29/66; B65H 29/46; B65H 29/20

(52) U.S. Cl. 399/38; 271/216; 271/84; 271/314; 399/405

(57) ABSTRACT

It is an object of the present invention to provide a paper discharge device that can sort sheets on a tray. The paper discharge device has paper discharge rollers, a tray and a driving mechanism. The paper discharge rollers are configured to discharge a sheet having an image formed thereon. The tray is configured to be stacked with the sheet discharged from the paper discharge rollers. The driving mechanism is configured to move the tray in a direction approaching the paper discharge rollers and a direction away from the paper discharge rollers and vary a stacking position of the sheet on the tray.

### CROSS-REFERENCE TO RELATED APPLICATION

This application is based upon and claims the benefit of priority from: U.S. provisional application 61/112,646, filed on Nov. 7, 2008; and U.S. provisional application 61/112,658, filed on Nov. 7, 2008, the entire contents of each of which are incorporated herein by reference.

### TECHNICAL FIELD

This specification relates to a paper discharge device that discharges sheets having images formed thereon to a tray and an image forming apparatus including the paper discharge device.

### BACKGROUND

In an image forming apparatus in the past, an image forming unit forms image on sheets and discharges the sheets having the images formed thereon to a paper discharge tray. The discharged sheets are stacked on the paper discharge tray in order.

The sheets discharged to the paper discharge tray may include those printed in different jobs and those printed by different users. The jobs include facsimile, printing, and copying. If plural sheets printed in different jobs or the like are simply stacked on the paper discharge tray, it is difficult to distinguish the sheets on the paper discharge tray.

### SUMMARY

According to an aspect of the present invention, there is provided a paper discharge device including: paper discharge rollers configured to discharge a sheet having an image formed thereon; a tray configured to be stacked with the sheet discharged from the paper discharge rollers; and a driving mechanism configured to move the tray in a direction approaching the paper discharge rollers and a direction away from the paper discharge rollers and vary a stacking position of the sheet on the tray.

According to another aspect of the present invention, there is provided a paper discharging method including moving a tray, which is configured to be stacked with a sheet discharged from paper discharge rollers, in a direction approaching the paper discharge rollers and a direction moving away from the paper discharge rollers and varying a stacking position of the sheet on the tray.

### DESCRIPTION OF THE DRAWINGS

FIG. 1 is an external view of the configuration of an image forming apparatus according to a first embodiment of the present invention;

FIG. 2 is an external view of a paper discharge device when a paper discharge tray stops in a first position in the first embodiment;

FIG. 3 is an external view of the paper discharge device when the paper discharge tray stops in a second position in the first embodiment;

FIG. 4 is a schematic diagram of a driving mechanism for the paper discharge tray according to the first embodiment;

FIG. 5 is a schematic diagram of a configuration for detecting the position of the paper discharge tray in the first embodiment;

FIG. 6 is an external view of the structure of a sheet processing mechanism according to a second embodiment of the present invention;

FIG. 7 is an external view of a driving mechanism for a rotating plate according to the second embodiment;

FIG. 8 is a front view of the sheet processing mechanism according to the second embodiment;

FIG. 9 is an external view of a structure for driving an arm in the second embodiment;

FIG. 10 is a side view of the sheet processing mechanism in a first state in the second embodiment;

FIG. 11 is a side view of the sheet processing mechanism in a second state in the second embodiment;

FIGS. 12A to 12L are diagrams for explaining sorting operation (an example) for sheets on a paper discharge tray according to the second embodiment;

FIG. 13 is an external view of the structure of a sheet processing mechanism according to a third embodiment of the present invention;

FIG. 14 is a side view of the sheet processing mechanism according to the third embodiment;

FIG. 15 is a schematic diagram of a supporting structure for a rack according to the third embodiment;

FIG. 16 is a side view of the sheet processing mechanism according to the third embodiment; and

FIGS. 17A to 17L are diagrams for explaining sorting operation (an example) for sheets on a paper discharge tray according to the third embodiment.

### DETAILED DESCRIPTION

Embodiments of the present invention are explained below with reference to the accompanying drawings.

### First Embodiment

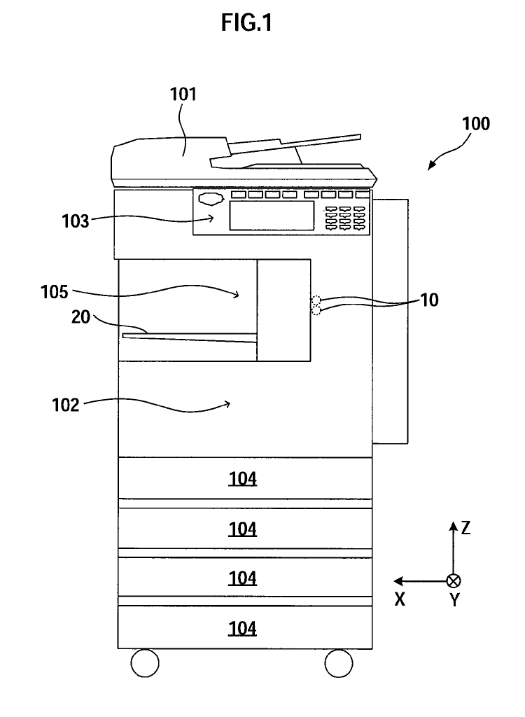

A paper discharge device according to a first embodiment of the present invention is explained below. First, an image forming apparatus including the paper discharge device according to this embodiment is explained with reference to FIG. 1.

FIG. 1 is an external view of the rough configuration of the image forming apparatus (MEP: Multi Function Peripheral). In FIG. 1, an X axis, a Y axis, and a Z axis are axes orthogonal to one another. The Z axis is an axis corresponding to an up-to-down direction of the image forming apparatus. A relation among the three axes X, Y, and Z is the same in other drawings.

An image forming apparatus 100 includes an image reading unit 101 and an image forming unit 102.

The image reading unit 101 has a function of scanning to read images of a sheet document and a book document. The image forming unit 102 has a function of forming a developer image on a sheet from, for example, image data generated by the reading operation of the image reading unit 101 or image data transmitted from an external apparatus (e.g., a personal computer) to the image forming apparatus 100. The sheet having the image formed thereon by the image forming unit 102 is conveyed to paper discharge rollers 10 explained later.

An operation panel 103 is used to input information concerning the operation of the image forming apparatus 100 and includes a display unit for displaying the information. Paper feeding cassettes 104 can be inserted in a main body of the image forming apparatus 100 (hereinafter referred to as apparatus main body) and removed from the apparatus main body. The paper feeding cassettes 104 store sheets to be conveyed to the image forming unit 102. In this embodiment, plural paper feeding cassettes 104 are inserted in the apparatus main body.

A paper discharge device 105 includes a paper discharge tray 20 on which sheets discharged from the paper discharge rollers 10 are stacked. A sheet S stacked on the paper discharge tray 20 can be extracted from a side opposed to the operation panel 103.

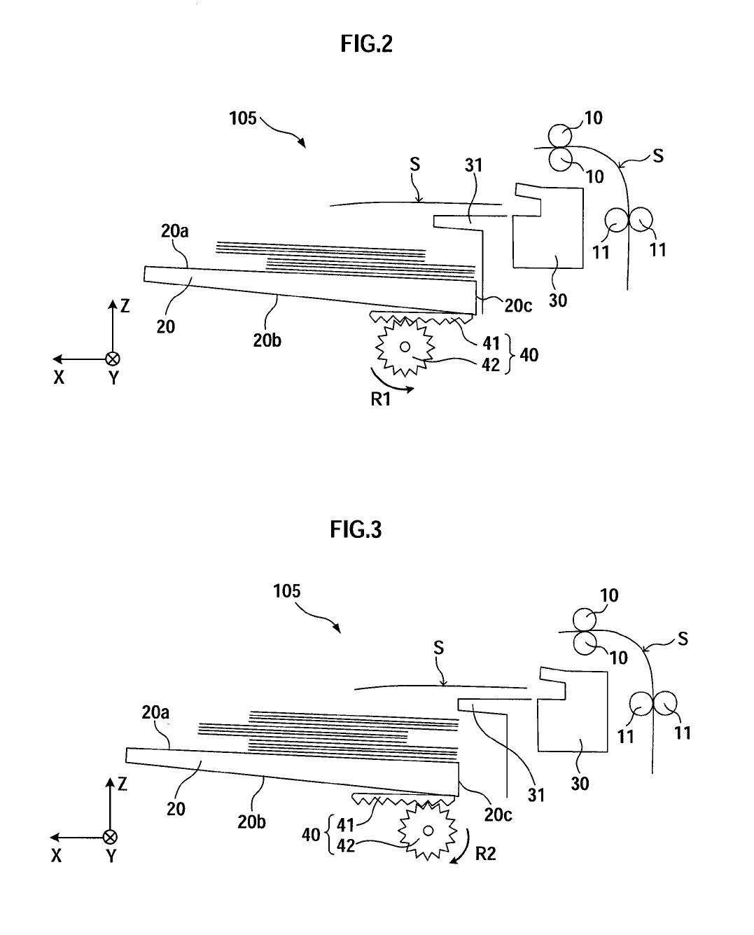

The structure of the paper discharge device 105 is explained below with reference to FIGS. 2 and 3.

Conveying rollers 11 convey the sheet S subjected to image processing in the image forming unit 102. The paper discharge rollers 10 discharge the sheet S. In FIG. 2, only a part of the conveying rollers 11 is shown.

When post processing is applied to the sheet S discharged from the paper discharge rollers 10, the paper discharge rollers 10 arrange the sheet S on a processing tray 31. In this embodiment, as the post processing, a stapler 30 can perform stapling.

The sheet S to be stapled is discharged to the paper discharge tray 20 after being processed by the stapler 30. The sheet S not to be stapled is directly discharged from the paper discharge rollers 10 to the paper discharge tray 20.

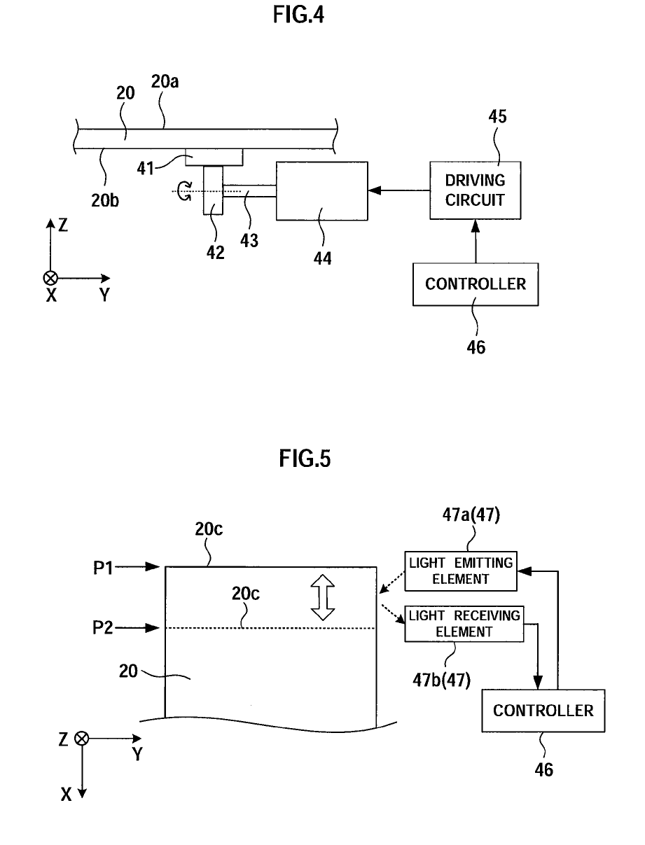

The sheet S is stacked on the upper surface (a stacking surface) 20a of the paper discharge tray 20. A driving mechanism 40 is arranged on a lower surface 20b side of the paper discharge tray 20. The driving mechanism 40 includes a rack 41 fixed to the lower surface 20b of the paper discharge tray 20 and a pinion 42 that meshes with the rack 41. As shown in FIG. 4, the pinion 42 is fixed to a rotating shaft 43 of a motor 44.

The motor 44 operates according to a driving signal from a driving circuit 45. A controller 46 controls the operation of the driving circuit 45.

When the motor 44 receives the driving signal from the driving circuit 45 and rotates, since the pinion 42 rotates, the rack 41 can be linearly moved in one direction. The moving direction of the rack 41 includes the moving direction of the sheet S discharged from the paper discharge rollers 10. When the rack 41 moves, the paper discharge tray 20 also moves.

If a guide section that supports the paper discharge tray 20 is provided in the main body of the image forming apparatus 100, the paper discharge tray 20 can be smoothly moved. The guide section only has to have a shape that can support the paper discharge tray 20. For example, the guide section can be formed in a projecting shape.

The paper discharge tray 20 moves between a position shown in FIG. 2 (a first position P1) and a position shown in FIG. 3 (a second position P2). When the paper discharge tray 20 stops in the first position P1, a proximal end 20c of the paper discharge tray 20 is closest to the processing tray 31. In other words, the paper discharge tray 20 is closest to the paper discharge rollers 10 in the X direction.

In a state shown in FIG. 2, when the pinion 42 is rotated in the direction of an arrow R1, the paper discharge tray 20 can be moved to the second position P2.

When the paper discharge tray 20 stops in the second position P2, the proximal end 20c of the paper discharge tray 20 is farthest away from the processing tray 31. In other words, the paper discharge tray 20 is farthest away from the paper discharger rollers 10 in the X direction.

In a state shown in FIG. 3, when the pinion 42 is rotated in the direction of an arrow R2, the paper discharge tray 20 can be moved to the first position P.

The position of the paper discharge tray 20 can be detected by using an optical sensor 47 as shown in FIG. 5. The optical sensor 47 includes a light emitting element 47a that irradiates detection light and a light receiving element 47b for receiving the detection light from the light emitting element 47a. The controller 46 controls to drive the driving of the light emitting element 47a. An output signal of the light receiving element 47b is input to the controller 46.

A position P1 shown in FIG. 5 indicates the position of the proximal end 20c when the paper discharge tray 20 is in the first position P1. A position P2 shown in FIG. 5 indicates the position of the proximal end 20c when the paper discharge tray 20 is in the second position P2. The proximal end 20c moves between the position P1 and the position P2.

When the paper discharge tray 20 stops in the first position P1, the detection light from the light emitting element 47a reflects on the paper discharge tray 20 and reaches the light receiving element 47b. When the paper discharge tray 20 stops in the second position P2, since the detection light from the light emitting element 47a does not reflect on the paper discharge tray 20, the detection light does not reach the light receiving element 47b.

When the position of the paper discharge tray 20 is switched, the output of the light receiving element 47b is switched. The controller 46 can discriminate the position of the paper discharge tray 20 by monitoring an output state of the light receiving element 47b.

The detection light from the light emitting element 47a is caused to reflect on the paper discharge tray 20 and reach the light receiving element 47b. Instead, for example, it is also possible to arrange the light emitting element 47a and the light receiving element 47b to be opposed to each other and move the paper discharge tray 20 between a position where the paper discharge tray 20 blocks the detection light traveling from the light emitting element 47a to the light receiving element 47b and a position where the paper discharge tray 20 does not block the detection light.

As means for detecting the position of the paper discharge tray 20, for example, a mechanical switch can be used instead of an optical sensor. In other words, a sensor that can discriminate the position of the paper discharge tray 20 only has to be used.

On the other hand, it is possible to move the paper discharge tray 20 between the first position P1 and the second position P2 simply by controlling the driving amount of the motor 44 without using the sensor. Specifically, it is also possible to discriminate the position of the paper discharge tray 20 by using a pulse motor as the motor 44 and counting the number of pulses input to the motor 44.

The operation of the paper discharge device 105 is explained below. First, the paper discharge tray 20 stops in the first position P1.

The paper discharge rollers 10 discharge a first sheet S having an image formed thereon and stack the sheet S on the paper discharge tray 20. Depending on a job (a first job), plural sheets S are stacked on the paper discharge tray 20. The plural sheets S overlap one another without being shifted from one another on the whole when viewed from a direction (the Z direction) orthogonal to the upper surface 20a of the paper discharge tray 20.

When the discharge of the sheet S is completed, the controller 46 drives the motor 44 via the driving circuit 45. Specifically, the controller 46 rotates the motor 44 in one direction (the arrow R1 direction in FIG. 2), whereby the paper discharge tray 20 moves from the first position P1 to the second position P2. When the paper discharge tray 20 moves, the position of the sheet S stacked on the paper discharge tray 20 also changes.

In the next job (a second job), the paper discharge tray 20 completes the movement to the second position P2 until an image is formed on the sheet S and the sheet S is discharged from the paper discharge rollers 10. In other words, the discharge of the sheet S from the paper discharge rollers 10 is prohibited until the paper discharge tray 20 moves to the second position P2.

After the paper discharge tray 20 moves to the second position P2, it is possible to discharge the sheet S from the paper discharge rollers 10 by controlling timing for forming an image on the sheet S and time until the sheet S having the image formed thereon is discharged from the paper discharge rollers 10.

When the sheet S is discharged to the paper discharge tray 20 that stops in the second position P2, the sheet S is stacked in a position shifted from the sheet S stacked on the paper discharge tray 20 in advance (the sheet S corresponding to the first job).

The sheet S discharged from the paper discharge rollers 10 moves to a paper discharge position. In other words, since the paper discharge rollers 10 rotates at fixed speed, a moving destination of the sheet S discharged from the paper discharge rollers 10 does not change. On the other hand, in this embodiment, since the paper discharge tray 20 moves between the first and second positions P1 and P2, the sheets S stacked on the paper discharge tray 20 are shifted from each other in the X direction.

When viewed from a direction orthogonal to the upper surface 20a of the paper discharge tray 20, the sheet S placed on the paper discharge tray 20 in the first position P1 and the sheet S placed on the paper discharge tray 20 in the second position P2 are shifted from each other in a paper discharge direction of the sheets S from the paper discharge rollers 10 (the X direction) while partially overlapping each other.

According to this embodiment, it is possible to stack the sheets S discharged to the paper discharge tray 20 in a shifted state simply by the paper discharge tray 20 moving between the first and second positions P1 and P2. In the image forming apparatus 100 of this embodiment, a space for discharging the sheets S is provided between the image forming unit 102 and the image reading unit 101. It is possible to sort the sheets S on the paper discharge tray 20 using a limited space without increasing the size of the image forming apparatus 100.

In this embodiment, a moving distance of the paper discharge tray 20 between the first and second positions P1 and P2 can be freely set. The sheets S discharged to the paper discharge tray 20 only have to be stacked in a distinguishable state. If the moving distance of the paper discharge tray 20 is too long, an end (an end on the opposite side of the proximal end 20c) of the paper discharge tray 20 projects far to the outside of the image forming apparatus 100.

The moving distance of the paper discharge tray 20 only has to be set from the viewpoint explained above. For example, the paper discharge tray 20 can be slid in the X direction in a range in which the end of the paper discharge tray 20 does not project to the outside of the image forming apparatus 100.

In this embodiment, the driving mechanism 40 arranged on the lower surface 20b side of the paper discharge tray 20 only has to be a mechanism that can move the paper discharge tray 20 between the first position P1 and the second position P2. For example, a driving mechanism for moving the paper discharge tray 20 can be provided on a side (an X-Z plane) of the paper discharge tray 20.

In this embodiment, the paper discharge tray 20 stops in the first and second positions P1 and P2. However, the paper discharge tray 20 can also stop in three or more positions. Sensors for detecting stop positions of the paper discharge tray 20 can be provided by the number of stop positions of the paper discharge tray 20.

### Second Embodiment

A paper discharge device according to a second embodiment of the present invention is explained below. The paper discharge device according to this embodiment sorts the sheets S discharged to a paper discharge tray to plural positions on the paper discharge tray. A structure for sorting the sheets S on the paper discharge tray is explained below.

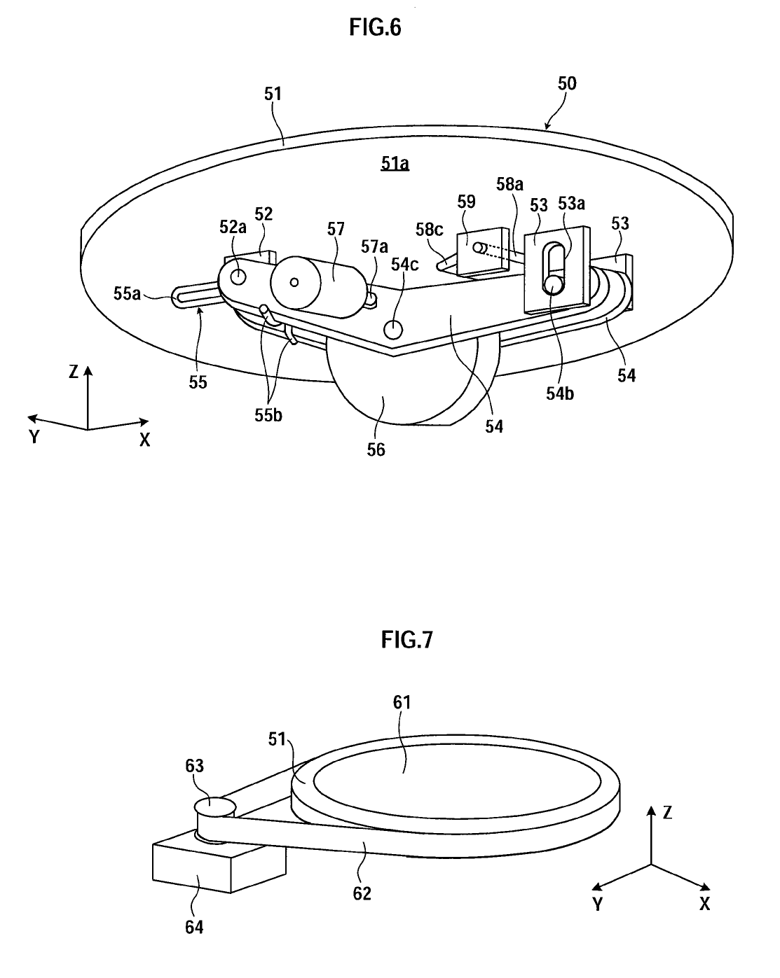

A sheet processing mechanism 50 shown in FIG. 6 is provided on a surface (an upper surface) opposed to the paper discharge tray in the Z direction. As shown in FIG. 7, a supporting unit 61 provided in the main body of the image forming apparatus 100 supports a rotating plate 51 of the sheet processing mechanism 50. The rotating plate 51 rotates relatively to the supporting unit 61. A belt 62 is arranged on the outer circumferential surface of the rotating plate 51. The belt 62 also comes into contact with the outer circumferential surface of a pulley 63.

The pulley 63 is fixed to an output shaft of a motor 64. The pulley 63 receives the driving force of the motor 64 and rotates. When the pulley 63 rotates, the belt 62 moves by the rotation amount of the pulley 63 and the rotating plate 51 rotates according to the movement of the belt 62.

A pair of first supporting sections 52 (see FIG. 8) are provided on a lower surface 51a of the rotating plate 51. A shaft member 52a is fixed to the pair of first supporting sections 52. Proximal ends of a pair of arms 54 are attached to both the ends of the shaft member 52a. The arms 54 can rotate around the shaft member 52a extending in the Z direction.

A coil spring 55 is arranged on the outer circumference of the shaft member 52a between the pair of arms 54. The center 55a of the coil spring 55 is set in contact with the lower surface 51a of the rotating plate 51. Arms 55b formed at both the ends of the coil spring 55 are respectively set in contact with end faces of the arms 54. The coil spring 55 urges the arms 54 in a direction approaching the lower surface 51a of the rotating plate 51.

Pins 54b are provided at the distal ends of the pair of arms 54. Second supporting sections 53 provided on the lower surface 51a of the rotating plate 51 support the pins 54b. Specifically, the pins 54b engage with guide holes 53a formed in the second supporting sections 53.

The second supporting sections 53 only have to be capable of supporting the pins 54b along moving tracks thereof. Specifically, grooves that do not pierce through the second supporting sections 53 can be used instead of the guide holes 53a that pierce through the second supporting sections 53.

A supporting shaft 54c is fixed in the centers (the centers in the X direction) of the arms 54. The supporting shaft 54c supports a sorting roller 56. The sorting roller 56 rotates relatively to the supporting shaft 54c. A motor 57 is fixed to one arm 54 via fixing sections 57a. A driving roller 57c is fixed to an output shaft 57b of the motor 57. The driving roller 57c is set in contact with the sorting roller 56. The driving roller 57c receives the driving force of the motor 57 and rotates, whereby the sorting roller 56 also rotates.

On the other hand, an arm driving member 58 for rotating the arms 54 is provided on the lower surface 51a of the rotating plate 51. Specifically, the arm driving member 58 has a shaft section 58a. A supporting section 59 provided on the lower surface 51a of the rotating plate 51 supports the shaft section 58a. The shaft section 58a rotates relatively to the supporting section 59.

A solenoid 70 has a movable pin 71 that moves according to the control of energization and fixes the distal end of the movable pin 71 to a first lever 58b of the arm driving member 58. When the movable pin 71 moves, the first lever 58b rotates in a direction indicated by an arrow R3 in FIG. 9. The solenoid 70 is fixed to the lower surface 51a of the rotating plate 51 in fixing sections 70a.

The arm driving member 58 has a second lever 58c fixed to the shaft section 58a. When the first lever 58b rotates, the second lever 58c rotates in a direction indicated by an arrow R4. In other words, the second lever 58c rotates in a direction same as the direction in which the first lever 58b rotates.

The pair of arms 54 are located below the second lever 58c. When the second lever 58c rotates, the second lever 58c pushes the pair of arms 54 in a direction away from the lower surface 51a of the rotating plate 51. Since the coil spring 55 urges the pair of arms 54 to the rotating plate 51 side, the arms 54 rotate against the urging force of the coil spring 55 according to the push-in by the second lever 58c.

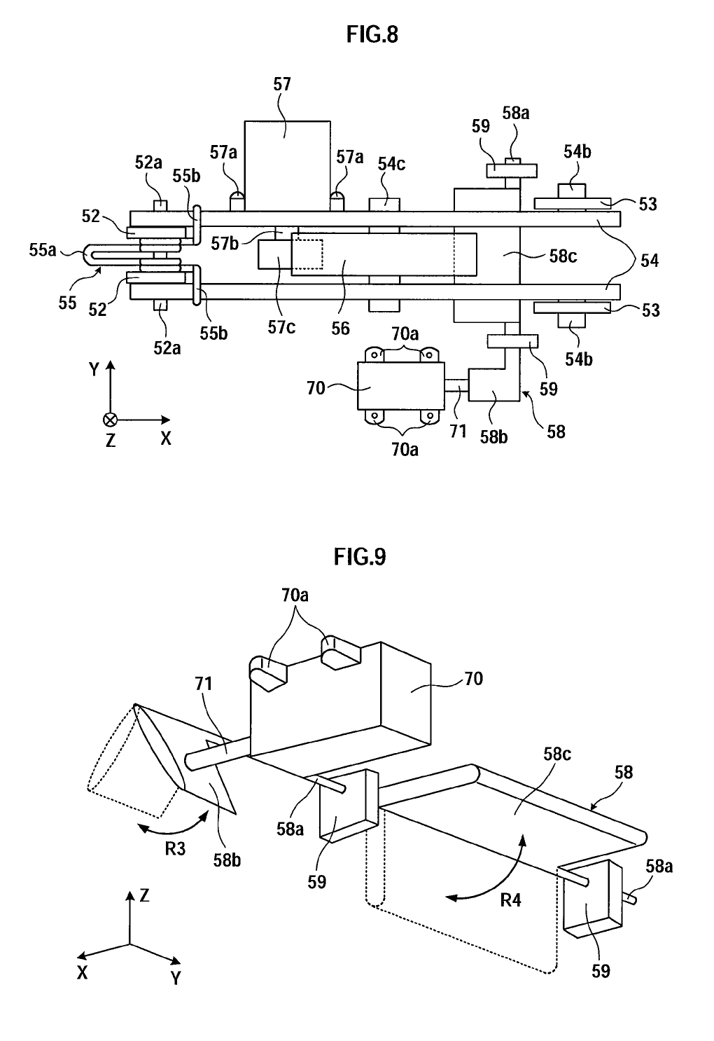

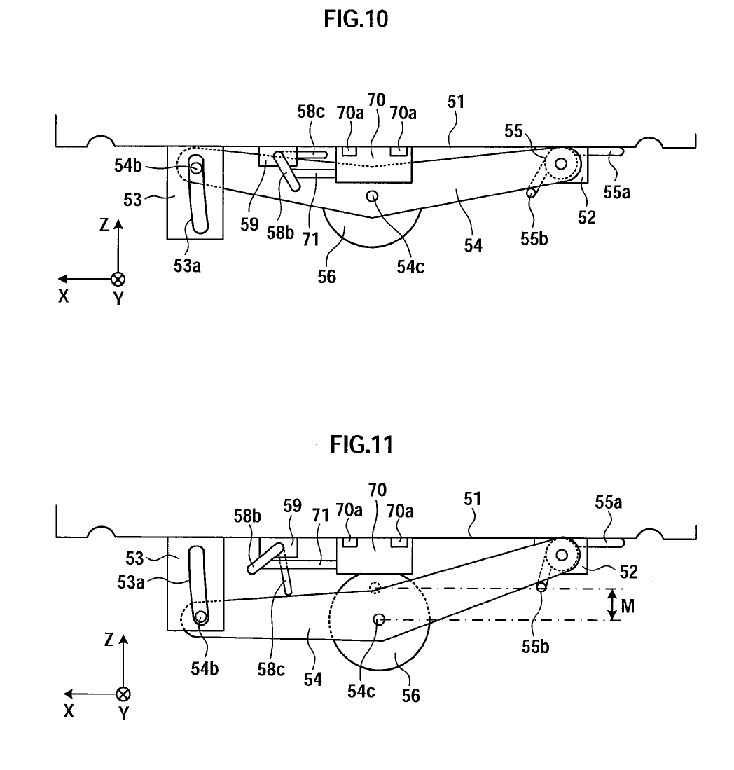

FIG. 10 is a diagram of a state in which the solenoid 70 is not energized. The pins 54b of the arms 54 receive the urging force of the coil spring 55 and are located at one ends of the guide holes 53a. In the state shown in FIG. 10, the second lever 58c does not push in the pair of arms 54.

In the state shown in FIG. 10, when the solenoid 70 is energized, the first lever 58b and the second lever 58c rotate as explained above. The second lever 58c pushes the arms 54 in the downward direction. The pins 54b of the arms 54 move along the guide holes 53a. The rotation amount of the arms 54 correspond to a moving distance of the pins 54b moving from one ends to the other ends of the guide holes 53a.

The sheet processing mechanism 50 changes to a state shown in FIG. 11. The sorting roller 56 moves downward by a distance M. The moving distance M is a distance for bringing the sorting roller 56 into close contact with the sheet S discharged onto the paper discharge tray.

In a state in which the sorting roller 56 is in close contact with the sheet S on the paper discharge tray, when the sorting roller 56 rotates according to the driving of the motor 57, the sheet S can move in a direction corresponding to the rotating direction of the sorting roller 56 according to the frictional force between the sorting roller 56 and the sheet S. Details of moving operation of the sheet S are explained later.

In the state shown in FIG. 11, when the energization to the solenoid 70 is interrupted, the push-in of the arms 54 by the second lever 58c is released. The arms 54 receive the urging force of the coil spring 55 to thereby return to the state shown in FIG. 10.

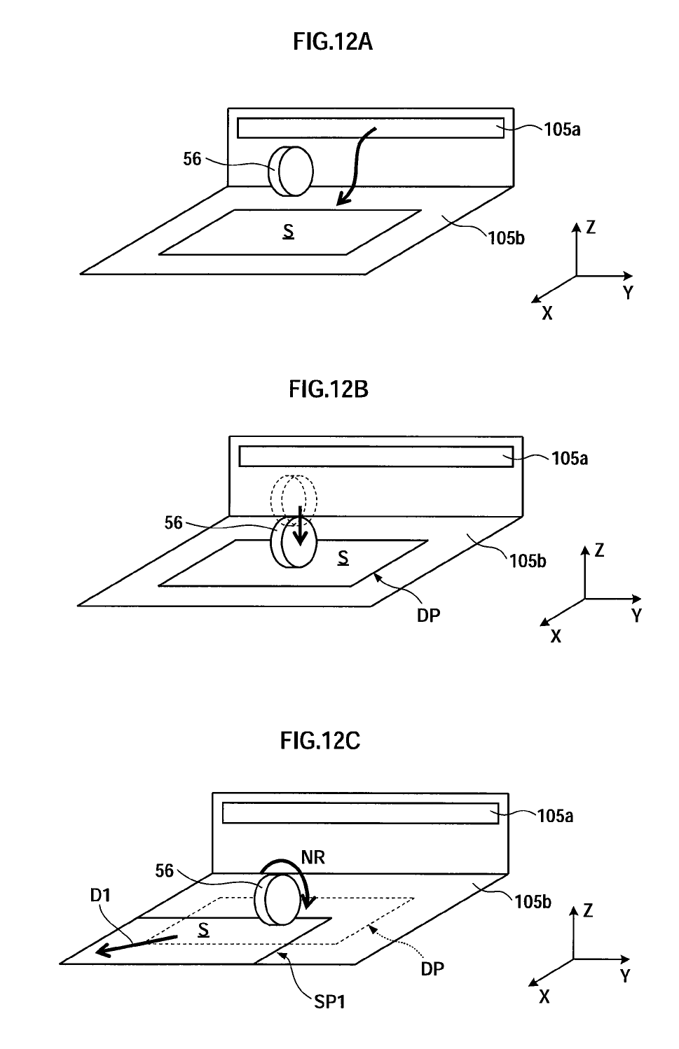

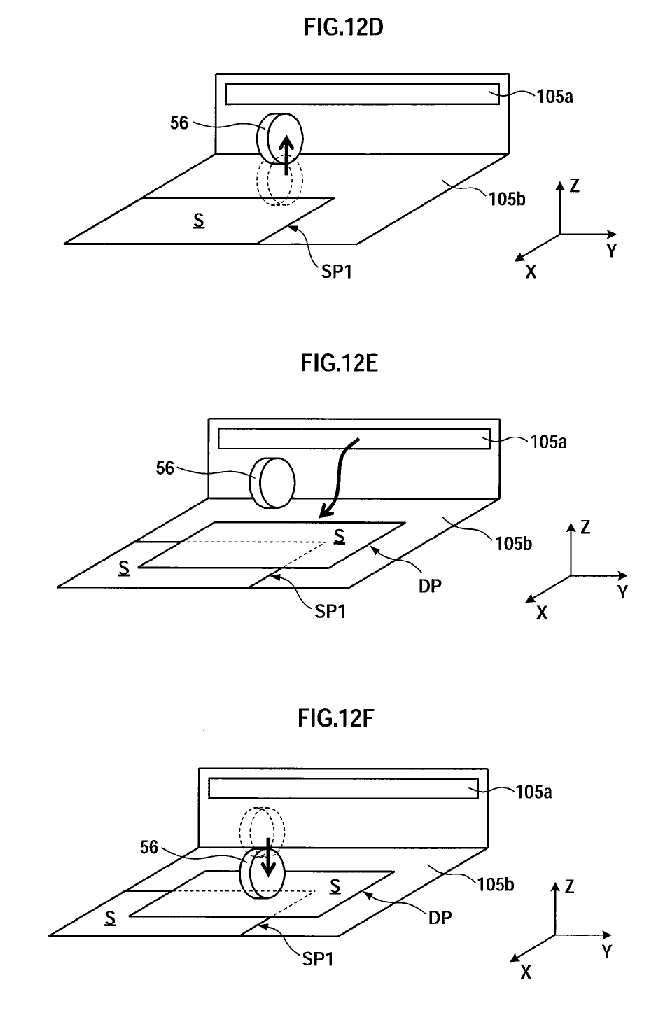

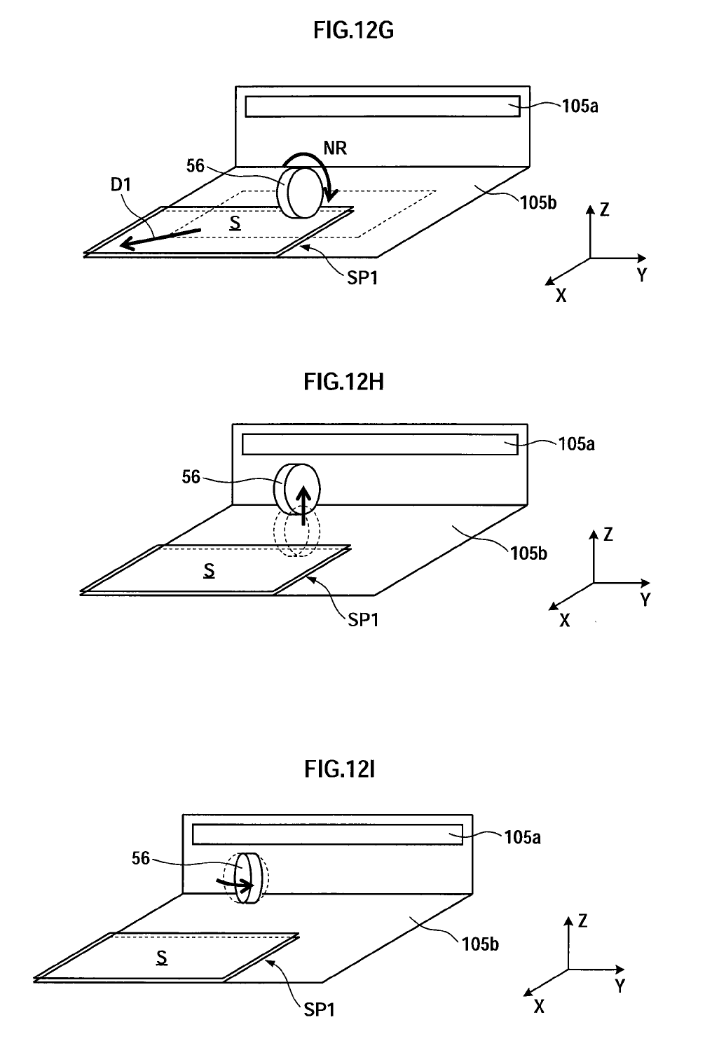

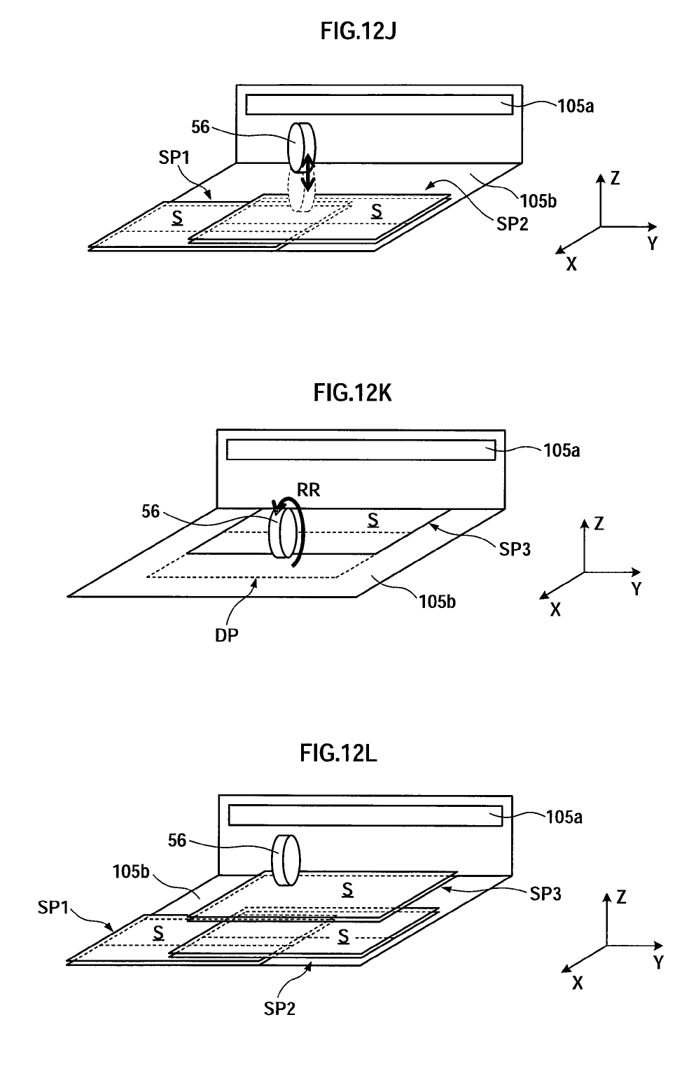

In this embodiment, the motor 64 is driven to rotate the rotating plate 51, whereby the direction of the sorting roller 56 changes in an X-Y plane. The solenoid 70 is energized, whereby the arm 54 rotates and the sorting roller 56 can move mainly in the Z direction. As shown in FIGS. 12A to 12L as an example, sheets can be sorted on the paper discharge tray. The operation of the sorting roller 56 is mainly explained with reference FIGS. 12A to 12L.

As shown in FIG. 12A, when the sheet S is discharged from a discharge port 105a, the sorting roller 56 stops in a position away from a paper discharge tray 105b (the position shown in FIG. 10). The sheet S discharged from the discharge port 105a is stacked on the paper discharge tray 105b without interfering with the sorting roller 56.

The sorting roller 56 turns to one direction according to the rotation of the rotating plate 51 involved in the driving of the motor 64.

The sheet S discharged from the discharge port 105a moves to an initial position DP on the paper discharge tray 105b. The initial position DP is a position where the sheet S discharged from the discharge port 105a simply drops on the paper discharge tray 105b.

When the sheet S moves to the initial position DP, the sorting roller 56 moves in the downward direction and comes into close contact with the sheet S (see FIG. 12B). The sorting roller 56 stops in the position shown in FIG. 11.

The sorting roller 56 rotates in a normal direction NR according to the driving force of the motor 57, whereby the sheet S moves in a direction indicated by an arrow D1 according to the frictional force between the sorting roller 56 and the sheet S (see FIG. 12C). The sheet S moves to a first sorting position SP1 on the paper discharge tray 105b. When the sorting roller 56 is in a state shown in FIG. 12A, the sorting roller 56 turns to a direction corresponding to the arrow D1.

It is possible to determine a moving distance (a moving distance in the X-Y plane) of the sheet S on the paper discharge tray 105b by adjusting the rotation amount of the sorting roller 56. When the sorting of the sheet S is completed, the sorting roller 56 moves in a direction away from the sheet S (see FIG. 12D).

Subsequently, the next sheet S is discharged from the discharge port 105a and moves to the initial position DP on the paper discharge tray 105b (see FIG. 12E). The sorting roller 56 moves downward and comes into close contact with the sheet S in the initial position DP (see FIG. 12F). The sheet S in the first sorting position SP1 and the sheet S in the initial position DP partially overlap each other when viewed from a direction orthogonal to the paper discharge tray 105b.

In a state shown in FIG. 12F, the direction of the sorting roller 56 is the same as that in a state shown in FIG. 12C. The sorting roller 56 rotates in the normal direction NR, whereby the sheet S moves to the first sorting position SP1 (see FIG. 12G).

Subsequently, the sorting roller 56 moves in the direction away from the sheet S and changes the direction thereof according to the rotation of the rotating plate 51 (see FIG. 121). After the direction of the sorting roller 56 is changed, as explained above, the sorting roller 56 moves downward and rotates in the normal direction NR.

The sheet S in the initial position DP moves to a second sorting position SP2 different from the first sorting position SP1 (see FIG. 12J). The first sorting position SP1 and the second sorting position SP2 coincide with each other in the X direction and shift from each other in the Y direction. The sheets S in the first and second sorting positions SP1 and SP2 overlap each other in the Y direction.

In this embodiment, the sheets S are sorted to three sorting positions SP1 to SP3 on the paper discharge tray 105b. When the sheet S moves to the third sorting position SP3, first, the rotating plate 51 rotates to thereby set the direction of the sorting roller 56 in a direction corresponding to the third sorting position SP3. The sorting roller 56 comes into close contact with the sheet S in the initial position DP and rotates in a reverse direction RR. As shown in FIG. 12K, the sheet S moves to the third sorting position SP3.

Since the sheets S move to the three sorting positions SP1 to SP3, as shown in FIG. 12L, plural sheets S are stacked on the paper discharge tray 105b.

According to this embodiment, it is possible to sort the sheets S having different contents efficiently using a space on the paper discharge tray 105b. In particular, in the image forming apparatus 100 explained in the first embodiment, the paper discharge device according to this embodiment can be used. The paper discharge device according to this embodiment is used for not only the image forming apparatus 100 explained in the first embodiment.

In this embodiment, the sorting roller 56 is located in the center of the paper discharge tray 105b when viewed from the Z direction. When plural sorting positions are provided on the paper discharge tray 105b, it is possible to shift sheets in the plural sorting positions from one another with high space efficiency by arranging the sorting roller 56 in the center.

In this embodiment, the sheets S can move to two or more sorting positions on the paper discharge tray 105b instead of moving to the three sorting positions SP1 to SP3 on the paper discharge tray 105b. It is possible to set the two or more sorting positions by setting the direction, the rotating direction, and the rotation amount of the sorting roller 56.

For example, in a configuration in which the sorting roller 56 is moved in the up-to-down direction (the Z direction), it is possible to sort the sheets S on the paper discharge tray 105b by switching the rotating direction of the sorting roller 56.

### Third Embodiment

A paper discharge device according to a third embodiment of the present invention is explained below. As in the second embodiment, the paper discharge device according to this embodiment sorts sheets, which are discharged to a paper discharge tray, to plural positions on the paper discharge tray.

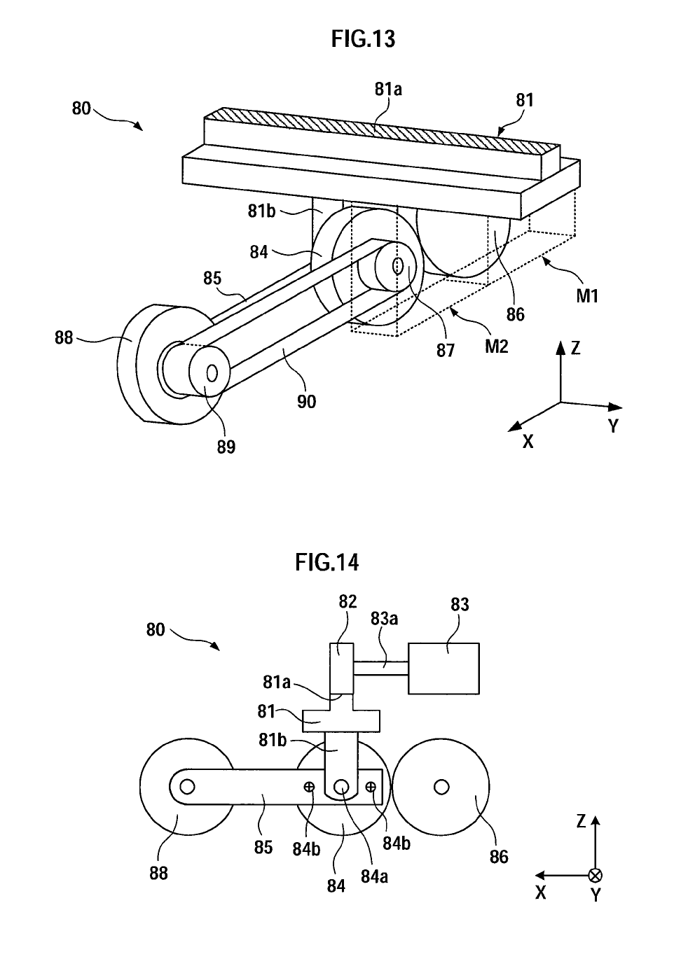

A sheet processing mechanism 80 shown in FIGS. 13 and 14 is provided on a surface (an upper surface) opposed to the paper discharge tray in the Z direction. A rack (a slide member) 81 of the sheet processing mechanism 80 meshes with a pinion 82. The pinion 82 is fixed to a rotating shaft 83a of a motor 83. In the rack 81 shown in FIG. 13, a gear section that meshes with the pinion 82 is formed in an area 81a indicated by hatching. The motor 83 is provided in the main body of the image forming apparatus 100.

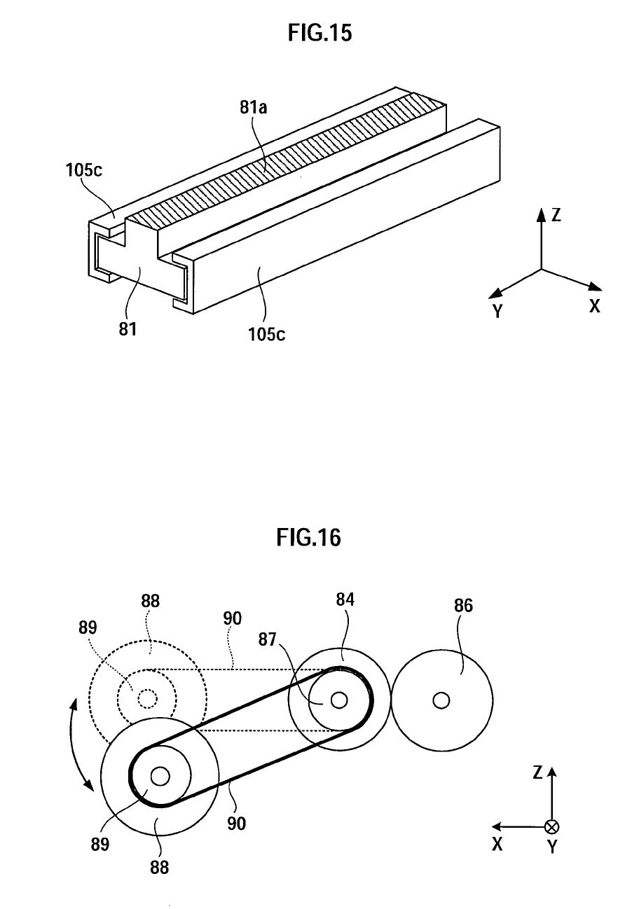

As shown in FIG. 15, the rack 81 is supported by a pair of guide rails 105c provided on the main body side of the image forming apparatus 100. When the pinion 82 receives the driving force from the motor 83 and rotates, the rack 81 moves in the Y direction along the guide rails 105c.

The rack 81 only has to move in one direction. A member different from that of the guide rails 105c shown in FIG. 15 can also be used for the rack 81.

A supporting section 81b that supports a driven gear 84 is provided on the lower surface of the rack 81. The driven gear 84 rotates relatively to the supporting section 81b. The driven gear 84 can rotate around a rotating shaft 84a. An arm 85 is fixed to the driven gear 84 by fastening bolts 84b. The arm 85 rotates around the rotating shaft 84a when the driven gear 84 rotates.

The driven gear 84 meshes with a driving gear 86. The driving gear 86 is connected to a motor M1. The driving gear 86 receives the driving force from the motor M1 and rotates.

A driving gear 87 is provided on the rotating shaft 84a of the driven gear 84. The driving gear 87 is attached to the rotating shaft 84a of the driven gear 84 and rotates relatively to the rotating shaft 84a. In other words, the driven gear 84 and the driving gear 87 are configured to be capable to rotate independently from each other.

The driving gear 87 is connected to a motor M2. The driven gear 84 receives the driving force from the motor M2 and rotates. The motors M1 and M2 are fixed to the rack 81.

A sorting roller 88 is provided at the distal end of the arm 85. The sorting roller 88 rotates relatively to the distal end of the arm 85. A driven gear 89 is fixed to the sorting roller 88. The driven gear 89 is connected to the driving gear 87 via a belt 90.

When the driving gear 87 rotates, the belt 90 moves and the driven gear 89 also rotates. The sorting roller 88 rotates together with the driven gear 89. If the rotating direction of the driving gear 87 is switched, the rotating direction of the sorting roller 88 can be switched.

When the driven gear 84 rotates and the arm 85 rotates, as shown in FIG. 16, the sorting roller 88 mainly moves in the Z direction. It is possible to set a moving distance of the sorting roller 88 in the Z direction by setting a rotation angle of the driven gear 84.

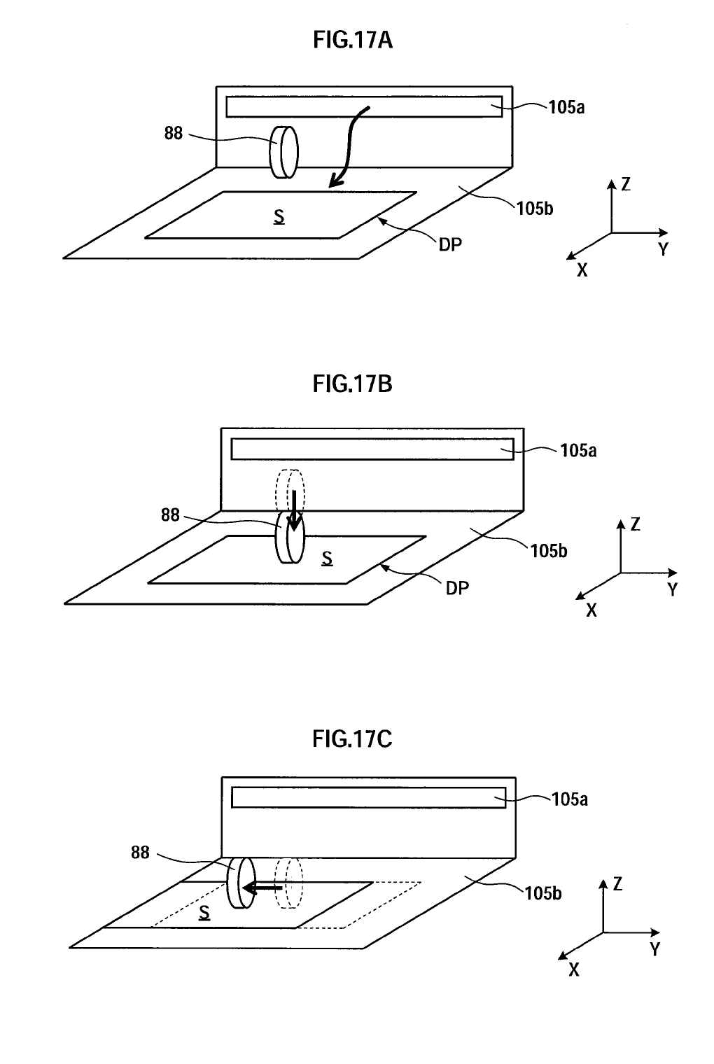

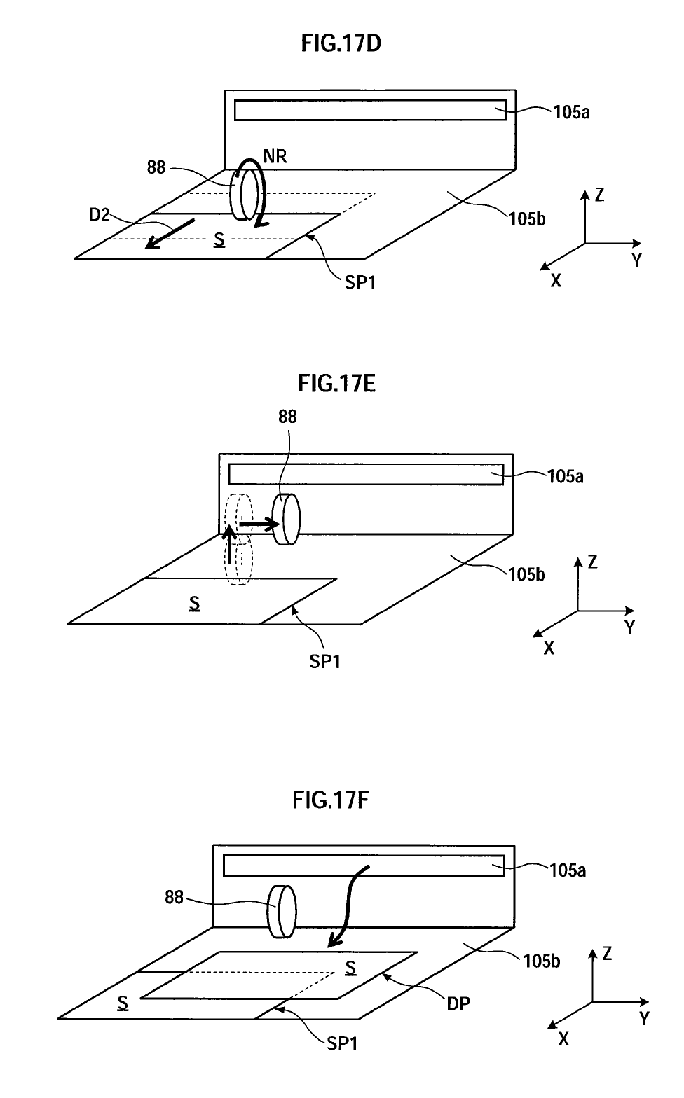

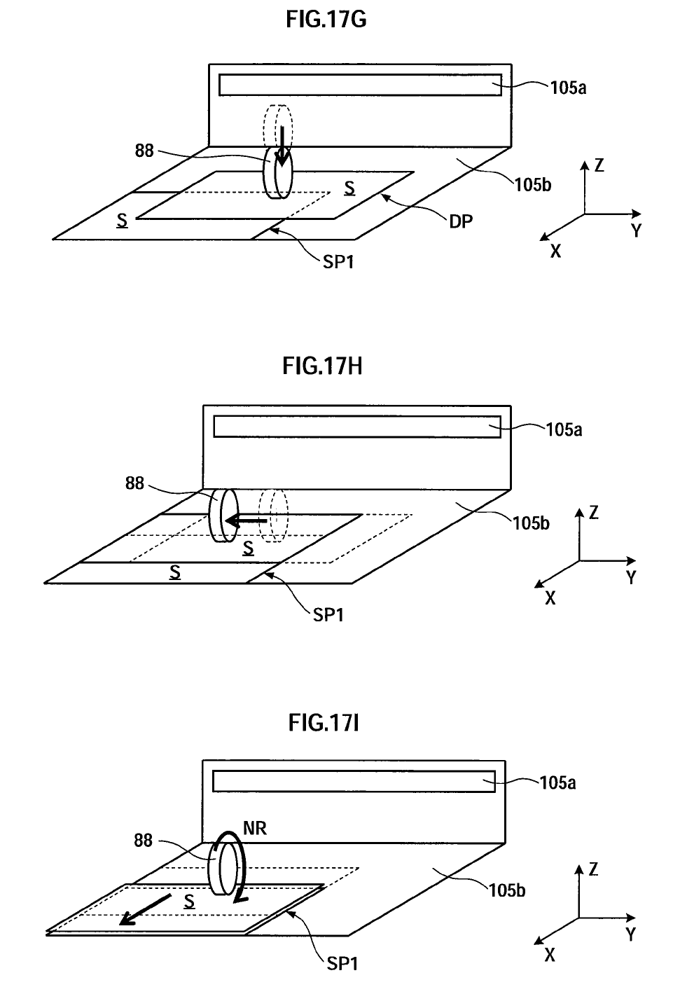

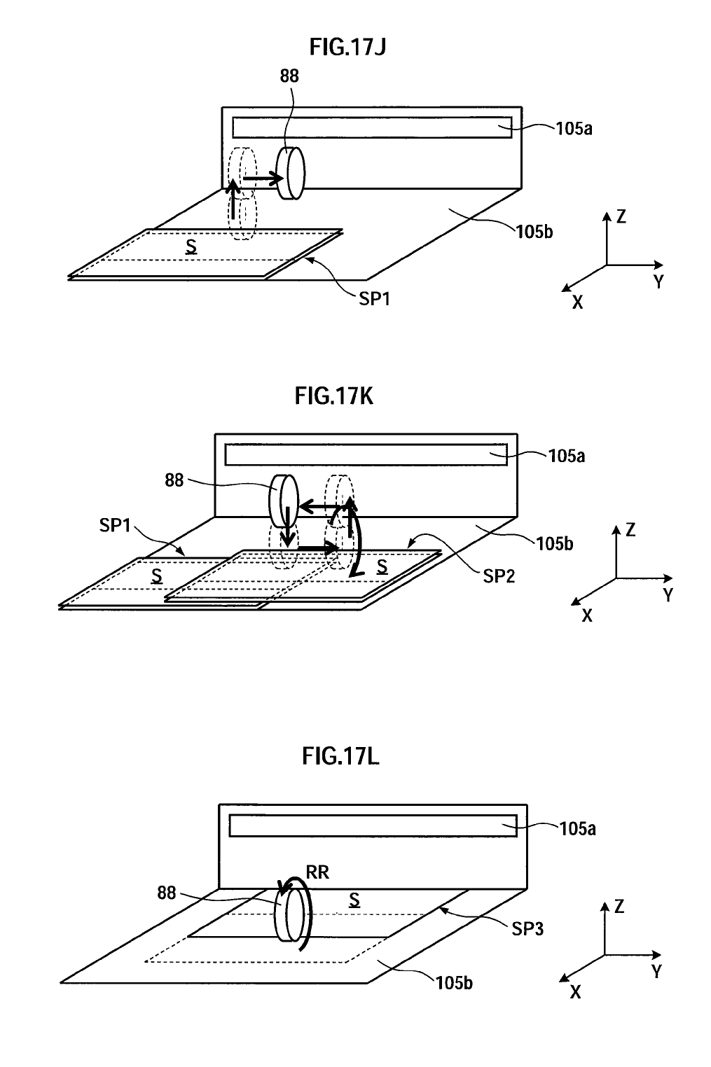

In this embodiment, the position of the sorting roller 88 in the Y direction can change according to the movement of the rack 81. The sorting roller 88 can mainly move in the Z direction according to the rotation of the driven gear 84. As shown in FIGS. 17A to 17L as an example, sheets can be sorted on the paper discharge tray 105b. The operation of the sorting roller 88 is mainly explained with reference to FIGS. 17A to 17L.

As shown in FIG. 17A, when the sheet S is discharged from the discharge port 105a, the sorting roller 88 stops in a position away from the paper discharge tray 105b (a position indicated by a dotted line in FIG. 16). The sheet S discharged from the discharge port 105a moves onto the paper discharge tray 105b without interfering with the sorting roller 88.

As explained in the second embodiment, the sheet S discharged from the discharge port 105a moves to the initial position DP on the paper discharge tray 105b. When the sheet S moves to the initial position DP, the sorting roller 88 moves in the downward direction and comes into close contact with the sheet S (see FIG. 17B). The sorting roller 88 stops in a position indicated by a solid line in FIG. 16.

When the pinion 82 rotates and the rack 81 moves, the sheet S can be moved in the moving direction of the rack 81 according to the frictional force between the sorting roller 88 and the sheet S (see FIG. 17C).

The sorting roller 88 rotates in the normal direction NR according to the driving force of the motor M2, whereby the sheet S moves in a direction indicated by an arrow D2 according to the frictional force between the sorting roller 88 and the sheet S (se FIG. 17D). The sheet S moves to the first sorting position SP1 on the paper discharge tray 105b. A moving distance of the sheet S in the direction of the arrow D2 can be determined by adjusting the rotation amount of the sorting roller 88.

When the sorting of the sheet S is completed, the sorting roller 88 returns to a reference position (see FIG. 17E). Specifically, first, the driving gear 86 reversely rotates, whereby the sorting roller 88 moves in the direction away from the sheet S. Subsequently, the pinion 82 rotates, whereby the rack 81 moves in a direction opposite to the last direction. In this embodiment, when viewed from the Z direction, the sorting roller 88 is located in the center (the reference position) of the paper discharge tray 105b.

Subsequently, the next sheet S is discharged from the discharge port 105a and moves to the initial position DP on the paper discharge tray 105b (see FIG. 17F). The sorting roller 88 moves downward and comes into close contact with the sheet S in the initial position DP (see FIG. 17G). The sheet S in the first sorting position SP1 and the sheet S in the initial position DP partially overlap each other when viewed from the direction orthogonal to the paper discharge tray 105b.

When the sheet S in the initial position DP moves to the first sorting position SP1, operation same as the operation explained above is performed (see FIGS. 17H and 17I). In the first sorting position SP1, plural sheets S are stacked. After the sheets S move to the first sorting position SP1, the sorting roller 88 returns to the reference position.

On the other hand, when the moving direction of the rack 81 is varied, the sheet S can move to the second sorting position SP2 (see FIG. 17K). Specifically, in a state in which the sorting roller 88 is in contact with the sheet S in the initial position DP, the rack 81 moves in a direction indicated by an arrow Y1. The sorting roller 88 rotates in the normal direction NR, whereby the sheet S slides to the second sorting position SP2.

The first sorting position SP1 and the second sorting position SP2 coincide with each other in the X direction and shift from each other in the Y direction. The sheets S in the first and second sorting positions SP1 and SP2 overlap each other in the Y direction.

On the other hand, if the rotating direction of the sorting roller 88 is varied, the sheet S can move to the third sorting position SP3 (see FIG. 17L). Specifically, the sorting roller 88 that stops in the reference position moves in the downward direction and comes into contact with the sheet S in the initial position DP. The sorting roller 88 rotates in the reverse direction RR, whereby the sheet S moves to the third sorting position SP3 using the frictional force between the sorting roller 88 and the sheet S.

In this embodiment, effects same as those in the second embodiment can be obtained.

In this embodiment, the sheet S moves to the three sorting positions SP1 to SP3 on the paper discharge tray 105b. However, it is also possible to cause the sheet S to move to two or more sorting positions on the paper discharge tray 105b. It is possible to set the two or more sorting positions by setting the rotating direction and the rotation amount of the sorting roller 88 and the moving direction of the rack 88.

A configuration in this embodiment is not limited to the configuration in which the sorting roller 88 rotates, whereby the sheet S moves in one direction.

Specifically, a contact member (equivalent to the sorting roller 88) that comes into contact with the sheet S stacked on the paper discharge tray 105b can also linearly move in each of the X direction, the Y direction, and the Z direction. In other words, the contact member can linearly move on the X-Y plane in a state in which the contact member keeps in contact with the sheet S. If racks that respectively move in the X direction and the Y direction are combined, the contact member can linearly move on the X-Y plane.

The second and third embodiments are materialization of inventions (1) to (19) explained below.

(1) A paper discharge device comprising:

a tray configured to be stacked with sheets discharged from paper discharge rollers;

a roller configured to come into contact with the sheets stacked on the tray and move the sheets to positions different from each other on the tray according to rotating operation; and

a driving mechanism configured to move the roller in a direction approaching the tray and a direction away from the tray.

(2) The device described in (1), wherein the driving mechanism rotates the roller around an axis orthogonal to a stacking surface of the tray.
(3) The device described in (2), wherein the driving mechanism moves the roller in the direction approaching the tray and brings the roller into contact with the sheets after rotating the roller around the axis.
(4) The device described in (1), wherein the driving mechanism stops the roller in a position away from the tray when a sheet is discharged from the paper discharge rollers.
(5) The device described in (1), wherein the roller moves the sheets to the positions different from each other on the tray by switching a rotating direction.
(6) The device described in (1), wherein the roller is arranged in a center of the tray when viewed from a direction orthogonal to a stacking surface of the tray.
(7) The device described in (1), wherein the sheets in the positions different from each other on the tray partially overlap each other when viewed from a direction orthogonal to a stacking surface of the tray.
(8) The device described in (1), wherein the driving mechanism includes:

an arm configured to support the roller at a distal end of the arm; and

a supporting member configured to support a proximal end of the arm, wherein

the driving mechanism moves the roller in the direction approaching the tray and the direction away from the tray by rotating the arm.

(9) The device described in (8), wherein the supporting member rotates around an axis orthogonal to a stacking surface of the tray.
(10) An image forming apparatus comprising:

an image forming unit configured to form an image on a sheet; and

the paper discharge device described in (1) configured to be located above the image forming unit.

(11) A paper discharge device comprising:

a tray configured to be stacked with sheets discharged from paper discharge rollers;

a contact member configured to come into contact with the sheets stacked on the tray; and

a driving mechanism configured to move the contact member in a direction approaching the tray and a direction away from the tray and move the contact member along a stacking surface of the tray.

(12) The device described in (11), wherein the driving mechanism stops the contact member in a position away from the tray when a sheet is discharged from the paper discharge rollers.
(13) The device described in (11), wherein the contact member is a roller that moves the sheets along the tray according to rotating operation.
(14) The device described in (13), wherein the roller moves the sheets to positions different from each other on the tray by switching a rotating direction.
(15) The device described in (11), wherein the sheets in the positions different from each other on the tray partially overlap each other when viewed from a direction orthogonal to the stacking surface of the tray.
(16) The device described in (11), wherein

the driving mechanism moves the contact member from an initial position, and

the contact member in the initial position is located in a center of the tray when viewed from a direction orthogonal to the stacking surface of the tray.

(17) The device described in (11), wherein the driving mechanism includes:

an arm configured to support the contact member at a distal end of the arm; and

a slide member configured to support a proximal end of the arm and moves in one direction in a plane orthogonal to the stacking surface of the tray.

(18) An image forming apparatus comprising:

an image forming unit configured to form an image on a sheet; and

the paper discharge device described in (11) configured to be located above the image forming unit.

(19) The apparatus described in (18), wherein the driving mechanism moves, for each print job, sheets to positions different from each other on a tray.

The present invention can be carried out in various forms without departing from main characteristics thereof. The embodiments are merely exemplars in every aspect and should not be limitedly interpreted. The scope of the present invention is indicated by the scope of claims. The text of the specification does not restrict the scope of the invention. All variations and various improvements, alterations, and modifications belonging to the scope of equivalents of the scope of claims are within the scope of the present invention.

What is claimed is:

1. A paper discharge device comprising:
paper discharge rollers configured to discharge a sheet having an image formed thereon;
a tray configured to be stacked with the sheet discharged from the paper discharge rollers; and
a driving mechanism configured to move the tray in a direction approaching the paper discharge rollers and a direction away from the paper discharge rollers and vary a stacking position of the sheet on the tray.

2. The paper discharge device according to claim 1, wherein the driving mechanism moves the tray between a first position near the paper discharge rollers and a second position farther away from the paper discharge rollers than the first position.

3. The paper discharge device according to claim 1, wherein the tray holds the sheets such that a parts of plural sheets stacked in positions different from each other on the tray are superimposed one on top of the other when viewed from a direction orthogonal to a stacking surface of the tray.

4. The paper discharge device according to claim 1, wherein the driving mechanism moves and stops the tray before the sheet is discharged from the paper discharge rollers.

5. The paper discharge device according to claim 1, wherein the driving mechanism includes:
a rack configured to be provided in the tray;
a pinion configured to be provided in an apparatus main body and mesh with the rack; and
a motor configured to be connected to the pinion.

6. The paper discharge device according to claim 1, further comprising a sensor configured to output information concerning a moving position of the tray.

7. The paper discharge device according to claim 1, wherein the paper discharge rollers rotate at fixed speed irrespectively of a moving position of the tray when the paper discharge rollers discharge the sheet.

8. The paper discharge device according to claim 1, wherein the sheet discharged from the paper discharge rollers moves to a paper discharging position irrespectively of a moving position of the tray.

9. An image forming apparatus comprising:
an image forming unit configured to form an image on a sheet; and
the paper discharge device according to claim 1 configured to be located above the image forming unit.

10. The image forming apparatus according to claim 9, further comprising a reading unit configured to be located above the paper discharge device and read an image.

11. The image forming apparatus according to claim 9, further comprising an operation panel configured to be operated to input information concerning image formation, wherein
the tray of the paper discharge device moves in a left-to-right direction when viewed from a direction opposed to the operation panel.

12. The image forming apparatus according to claim 9, wherein the tray moves in a range in which the tray does not project from a side of the image forming apparatus.

13. The image forming apparatus according to claim 9, further comprising a controller configured to control operation of the driving mechanism of the paper discharge device, wherein
the controller moves the tray via the driving mechanism when a print job is switched.

14. A paper discharging method comprising moving a tray, which is configured to be stacked with a sheet discharged from paper discharge rollers, in a direction approaching the paper discharge rollers and a direction away from the paper discharge rollers and varying a stacking position of the sheet on the tray.

15. The paper discharging method according to claim 14, further comprising moving the tray between a first position near the paper discharge rollers and a second position farther away from the paper discharge rollers than the first position.

16. The paper discharging method according to claim 14, further comprising superimposing parts of plural sheets stacked in positions different from each other on the tray one on top of the other when viewed from a direction orthogonal to a stacking surface of the tray.

17. The paper discharging method according to claim 14, further comprising moving and stopping the tray before the sheet is discharged from the paper discharge rollers.

18. The paper discharging method according to claim 14, further comprising rotating the paper discharge rollers at fixed speed irrespectively of a moving position of the tray when the paper discharge rollers discharge the sheet.

19. The paper discharging method according to claim 14, further comprising moving the sheet discharged from the paper discharge rollers to a paper discharging position irrespectively of a moving position of the tray.
